(19) United States
(12) Patent Application Publication
(10) Pub. No.: US 2025/0356829 A1
(43) Pub. Date: Nov. 20, 2025

(54) CONSTRUCTION METHOD AND USE OF DEEP LEARNING-BASED DENOISING MODEL

(71) Applicants: Innovation Center of Yangtze River Delta, ZJU, Jiaxing City (CN); Zhejiang University, Hangzhou City (CN)

(72) Inventors: Yonggang SHEN, Jiaxing City (CN); Tuqiao ZHANG, Jiaxing City (CN); Tingchao YU, Jiaxing City (CN); Hongliang YU, Jiaxing City (CN)

(21) Appl. No.: 18/925,418

(22) Filed: Oct. 24, 2024

(30) Foreign Application Priority Data
May 15, 2024 (CN) 202410604897.2

(51) Int. Cl. G10K 11/16; G06N 3/0455; G06N 3/0464

(52) U.S. Cl. CPC G10K 11/16; G06N 3/0455; G06N 3/0464

(57) ABSTRACT

A construction method of a deep learning-based pipeline leakage detection and denoising model: performing signal modulation on clean signals and noise signals in different proportions to obtain noisy signals; performing short-time Fourier transform (STFT) on the clean signals to extract spectral amplitudes of the clean signals, and using absolute values of the spectral amplitudes of the clean signals as target samples; performing STFT on the noisy signals to obtain spectral amplitudes of the noisy signals, calculating absolute values of the spectral amplitudes of the noisy signals, correcting the absolute values of the spectral amplitudes of the noisy signals, and using the corrected spectral amplitudes as training samples; normalizing amplitudes of the training samples and the target samples, and then inputting the amplitudes into a denoising convolutional encoding-decoding neural network for training; and optimizing the trained denoising convolutional encoding-decoding neural network to obtain a pipeline leakage detection and denoising model.

### CROSS REFERENCE TO RELATED APPLICATION

This patent application claims the benefit and priority of Chinese Patent Application No. 202410604897.2, filed with the China National Intellectual Property Administration on May 15, 2024, the disclosure of which is incorporated by reference herein in its entirety as part of the present application.

### TECHNICAL FIELD

The present disclosure relates to the field of pipeline leakage detection and denoising technologies, and in particular, to a construction method and use of a deep learning-based denoising model.

### BACKGROUND

With the development of cities, urban water supply pipe networks are being laid increasingly denser. Some water supply pipe networks, due to their early laying time or other external forces, inevitably experience dripping or leakage. Currently, a leakage detection method is an acoustic or vibration method, and mainly includes pipe wall detection and out-of-pipe detection. In pipe wall detection, a correlation method is used to position a leakage loss point because the accuracy of a TDE can be improved when a signal is preprocessed by a filter. The filter has increasingly powerful preprocessing functions, and a capability of the correlation method at a low signal-to-noise ratio is improved. Although these methods have achieved good results in metal pipes, applications are limited due to the quick attenuation of signals in plastic pipes. Out-of-pipe detection usually needs to rely on experienced test personnel to analyze a ground vibration signal by using a listening rod and an electronic leak detector, to realize accurate positioning. Although the out-of-pipe detection based on the ground vibration signal has good positioning accuracy, this method relies heavily on working experience of the detection personnel. Consequently, an analysis result is subjective, and a large amount of time is required, but efficiency is low.

In the out-of-pipe detection, a complex pipe network system and a sound vibration propagation rule do not need to be modeled, and a ground vibration signal on a leakage site is directly analyzed, resulting in a significantly reduced positioning error. Combining vibration signals collected on the ground with an intelligent algorithm can significantly improve positioning efficiency. However, a leakage detection result of a pipe wall sound vibration signal based on the intelligent algorithm is greatly affected by a model parameter, and often has a relatively large deviation from an actual leakage position, and therefore is more suitable for intelligent pipeline warning. Ground acoustic vibration detection based on the intelligent algorithm can achieve high positioning accuracy. However, current researches still focus on manually extracted features, and selected features determine a detection effect of the model. Too few features affect performance of the model. Too many features slow down an analysis speed, and also ignore analysis of a normal signal. A water supply network manager usually chooses to perform health diagnosis on a pipeline when there is less traffic flow or people flow, and needs to perform leakage detection at midnight when necessary. This can reduce impact exerted by ambient noise on the detection. The detection personnel usually judge the leakage based on subjective experience, and therefore, the least noise is expected. Similarly, an intelligent leakage detection model is constructed based on a database constructed by using signals in an experimental or actual leakage condition. The database is rarely doped with noise, and a model trained by using a clean signal in the database may be relatively sensitive to a noise signal. Therefore, when leakage is found near a suspected leakage area, if there is a fixed noise source nearby, not only interference is caused to determining by professional detection personnel, but also use of an intelligent algorithm for leakage detection is limited. Therefore, a to-be-detected signal needs to be enhanced by using a denoising algorithm, and a to-be-identified leakage-related signal needs to be extracted from a noisy signal, so as to facilitate operation of the detection personnel and further improve the applicability of the intelligent algorithm.

### SUMMARY

To solve the above technical problems, the present disclosure provides the following technical solutions.

The present disclosure provides a construction method of a deep learning-based pipeline leakage detection and denoising model, where the construction method includes:
(1) performing signal modulation on clean signals and noise signals in different proportions to obtain noisy signals with different signal-to-noise ratios;
(2) performing short-time Fourier transform (STFT) on the clean signals to extract spectral amplitudes of the clean signals, and using absolute values of the spectral amplitudes of the clean signals as target samples for model training;
(3) performing STFT on the noisy signals to obtain spectral amplitudes of the noisy signals, calculating absolute values of the spectral amplitudes of the noisy signals, correcting the spectral amplitudes of the noisy signals by using a phase aware scaling (PAS) algorithm, and using the corrected spectral amplitudes as training samples;
(4) normalizing amplitudes of the training samples and the target samples, and then inputting the amplitudes into a denoising convolutional encoding-decoding neural network for training; and
(5) optimizing the denoising convolutional encoding-decoding neural network by using a loss function to obtain a pipeline leakage detection and denoising model.

The noise signal includes a stationary noise signal such as Gaussian white noise, and also includes non-stationary noise such as traffic noise. A signal such as wind sound, rain sound, and traffic noise in an ESC-50 data set may be selected as a noise source for a synthesized signal.

Further, the noisy signal in step (1) is obtained by scaling the noise signal and superimposing scaled noise with the clean signal;
when it is assumed that the noise signal is d(n), and the clean signal is x(n), the noisy signal y(n) is:

$$y ( n ) = x ( n ) + α d ( n ) ;$$

and
a signal-to-noise ratio SNR of the noisy signal y(n) is:

$$SNR = 10 {log}_{10} \frac{{\sum }_{i = 1}^{n} {x}^{2} ( n )}{{\sum }_{i = 1}^{n} {d}^{2} ( n )} ;$$

where
α is a scaling coefficient and is calculated according to the following formula:

$$α = \sqrt{\frac{{\sum }_{i = 1}^{n} {x}^{2} ( n )}{{10}^{\frac{SNR}{10}} {\sum }_{i = 1}^{n} {d}^{2} ( n )}} ;$$

further, a formula of STFT is:

$${S}_{n} = {e}^{- jwn} [ x ( n ) * w ( n ) ] {e}^{jwn} ; where$$

$$w ( n ) = \{ \begin{matrix}0.54 - 0.46 cos [ \frac{2 π n}{L - 1} ] & 0 \leq n \leq L - 1 \\ 0 & else\end{matrix} ,$$

L is a window length, and
w(n) is a Hamming window function.

Further, considering a correlation of single frames, surrounding frames are concatenated together as a training sample, and an expression of the training sample is:

$$Training data = \{ \begin{matrix}sample : ( {S}_{noisy ( n - 3 )} , {S}_{noisy ( n - 2 )} , … , {S}_{noisy ( n + 3 )} ) \\ target : {S}_{clean ( n )}\end{matrix} ;$$

where
S_{clean} is a signal obtained after STFT is performed on the clean signal x(n); and
S_{noisy} is a signal obtained after STFT is performed on the noisy signal y(n).

Further, to reduce an error of the training sample, phase aware scaling (PAS) is introduced to reduce an error caused by a phase change. Only when a phase difference between the noisy signal and the clean signal is less than 45 degrees, human ears are insensitive to distortion caused by a phase change of a signal. A formula for correcting a spectral amplitude of the noisy signal by using the PAS algorithm based on this principle is:

$${S}_{PAS} = {S}_{noisy} cos ( {θ}_{clean} - {θ}_{noisy} ) ;$$

θ_{clean} represents a phase angle of the clean signal; and
θ_{noisy} represents a phase angle of the noisy signal.

Further, normalization processing is separately performed on the training sample and a target vector. Through normalization processing, not only a convergence speed is accelerated, but an effect exerted by a singular sample value with relatively large or small overall data on model training is also eliminated. A formula for normalizing the amplitudes of the training samples is:

$${S}_{noisy \_ re} = [ {S}_{noisy} - mean ( {S}_{noisy} ) ] / std ( {S}_{noisy} )$$

a formula for normalizing the amplitudes of the target samples is:

$${S}_{clean \_ re} = [ {S}_{clean} - mean ( {S}_{clean} ) ] / std ( {S}_{clean} ) ;$$

S_{clean} is a signal obtained after STFT is performed on the clean signal x(n); and

S_{noisy} is a signal obtained after STFT is performed on the noisy signal y(n).

Further, the denoising convolutional encoding-decoding neural network extracts features in the first convolutional layer, allows the extracted features to enter a normalization layer (BN layer) and an activation layer (ReLU layer) in sequence, and then to a first convolutional module, then output data enters n denoising blocks, where a value of n is capable of being flexibly adjusted; when an input of the block is transferred to the first convolutional module N1, a dimension is first raised to obtain more features, and when an extracted feature of the first convolutional module N1 is transferred to a second convolutional module N2, a convolution kernel becomes smaller, and a local receptive field becomes smaller, to reduce leakage of features, and a quantity of channels is increased to ensure that no feature is lost. This process is an encoding (Encode) process. When an extracted feature of the second convolutional module N2 is transferred to a third convolutional module N3, the convolution kernel becomes large again, and because the perception field becomes large, a feature extraction capability becomes strong, and to reduce a calculation amount and reduce the quantity of channels, feature decoding (Decode) is implemented; finally, an output of the third convolutional module N3 is mixed with an input of the entire module by using a residual connection, to implement feature fusion; mixed features are activated by using the activation layer (ReLU layer), and an output result continues to be transferred to a next module; and at the last convolutional layer Conv last, a quantity of convolution kernels needs to be adjusted to 1 to keep consistent with the target vector, and finally, a training effect is calculated by using a regression layer loss function.

The convolutional layer: In a convolution operation, an input feature and the convolution kernel are multiplied first in a one-dimensional convolution direction, then results are accumulated, a new feature is output, and features are extracted in a frequency domain dimension.

Normalization layer: A batch normalization (BN) layer is used, and only one batch is iterated at a time. Data of different batches also has different distribution, so that data of each batch meets standard normal distribution.

Activation layer: A rectified linear unit (ReLU) function is used as an activation function. A calculation formula is f(x)=max(0, x).

Regression layer: A prediction capability of the model is evaluated by calculating half of a root mean squared error of a predicted value and a target value. The loss function is calculated according to the following:

$$loss = \frac{1}{2} {\sum }_{i = 1}^{R} {\sum }_{f = 1}^{F} {( {\hat{x}}_{i , f} ( {y}_{i , f} , W , b ) - {x}_{i , f} )}^{2} .$$

In the formula, loss represents an error value, R is a quantity of input frames, F is a frequency of a signal, x_{i,f} is a target value at a time-frequency point (i, f), that is, an amplitude of a clean spectrum signal, y_{i,f}, W, b respectively represent an input, a weight, and an offset, and î_{i,f} is a response to the model.

Further, the loss function is calculated according to the following formula:

$$loss = \frac{1}{2} {\sum }_{i = 1}^{R} {\sum }_{f = 1}^{F} {( {\hat{x}}_{i , f} ( {y}_{i , f} , W , b ) - {x}_{i , f} )}^{2}$$

loss represents an error value;
R represents a quantity of input frames;
F is a frequency of a signal;
x_{i,f} is a target value at a time-frequency point (i, f), that is, an amplitude of a clean spectrum signal;
y_{i,f}, W, b respectively represent an input, a weight, and an offset; and
\hat{x}_{i,f} is a response to the pipeline leakage detection and denoising model.

The present disclosure provides a deep learning-based pipeline leakage detection and denoising model, and the pipeline leakage detection and denoising model is constructed by using the foregoing construction method.

The present disclosure provides a use of a deep learning-based pipeline leakage detection and denoising model to water supply pipeline leakage detection, and specific leakage detection steps are as follows:

STFT is performed on an unknown signal on which denoising needs to be performed. In this case, in addition to obtaining a frequency amplitude of a signal, a phase value of the signal needs to be reserved, and the phase value is used as a phase value of a reconstructed signal. An extracted amplitude is input into a trained deep learning model to obtain an estimated spectral amplitude of a clean signal. The signal is reconstructed through ISTFT, and an estimated signal is converted from a frequency domain dimension to a time domain dimension, thereby implementing signal denoising.

The present disclosure has the following beneficial effects:
(1) In the present disclosure, a mapping relationship between a noisy signal and a clean signal is learned by using a learning capability of a neural network for big data, to construct an adaptive denoising model. The denoising model does not need to make a hypothesis for a signal nature as in a conventional algorithm, so that non-stationary noise can be effectively removed, and a training library of a model is expanded with a purpose.
(2) In the present disclosure, an adaptive denoising convolutional encoding-decoding neural network is established, and a residual connection is introduced, so that a network structure can be flexibly adjusted, and an update may be performed frequently. A better denoising model is obtained through repeated iterations, to prevent a gradient from disappearing due to an excessively long denoising network, and such algorithms can be easily applied by leakage detection personnel without professional denoising knowledge.

### BRIEF DESCRIPTION OF THE DRAWINGS

FIG. 1 is a flowchart of a construction method of a leakage detection and denoising model in the present disclosure;

FIG. 2 is a schematic diagram of a basic framework of a model in the present disclosure;

FIG. 3 is a diagram of a basic structure of a denoising block in the present disclosure;

FIGS. 4A-4G are time-history graph of signals obtained after denoising processing is performed for stationary noise by using a conventional denoising algorithm and a constructed model in the present disclosure;

FIGS. 5A-5G are STFT spectrum diagram of signals obtained after denoising processing is performed for stationary noise by using a conventional denoising algorithm and a constructed model in the present disclosure;

FIG. 6 is an evaluation indicator diagram for a stationary denoising algorithm;

FIGS. 7A-7G are time-history graph of signals obtained after denoising processing is performed for non-stationary noise by using a conventional denoising algorithm and a constructed model in the present disclosure;

FIGS. 8A-8G are STFT spectrum diagram of signals obtained after denoising processing is performed for non-stationary noise by using a conventional denoising algorithm and a constructed model in the present disclosure; and

FIG. 9 is an evaluation indicator diagram for a non-stationary denoising algorithm.

### DETAILED DESCRIPTION OF THE EMBODIMENTS

The following describes in detail specific implementations of the present disclosure with reference to the accompanying drawings. It should be noted that the embodiments are merely specific descriptions of the present disclosure, and should not be considered as limitations on the present disclosure. An objective of the embodiments is to enable a person skilled in the art to better understand and reproduce the technical solutions of the present disclosure. The protection scope of the present disclosure still falls within the scope of the claims.

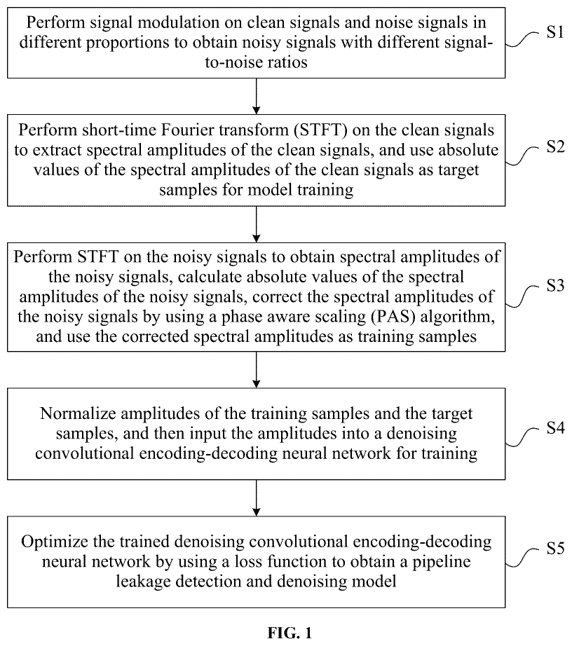

As shown in FIG. 1, the present disclosure provides a construction method of a deep learning-based pipeline leakage detection and denoising model. The construction method includes the following steps:

In S1, signal modulation is performed on clean signals and noise signals in different proportions to obtain noisy signals with different signal-to-noise ratios.

The noise signal includes a stationary noise signal such as Gaussian white noise, and also includes non-stationary noise such as traffic noise. A signal such as wind sound, rain sound, and traffic noise in an ESC-50 data set may be selected as a noise source for a synthesized signal.

The noisy signal is obtained by scaling the noise signal and superimposing scaled noise with the clean signal.

When it is assumed that the noise signal is d(n), and the clean signal is x(n), the noisy signal y(n) is:

$$y ( n ) = x ( n ) + α d ( n ) .$$

A signal-to-noise ratio SNR of the noisy signal y(n) is:

$$SNR = 10 {log}_{10} \frac{{\sum }_{i = 1}^{n} {x}^{2} ( n )}{{\sum }_{i = 1}^{n} {d}^{2} ( n )} ;$$

where
α is a scaling coefficient and is calculated according to the following formula:

$$α = \sqrt{\frac{{\sum }_{i = 1}^{n} {x}^{2} ( n )}{{10}^{\frac{SNR}{10}} {\sum }_{i = 1}^{n} {d}^{2} ( n )}} .$$

In S2, STFT is performed on the clean signals to extract spectral amplitudes of the clean signals, and absolute values of the spectral amplitudes of the clean signals are used as target samples for model training.

A formula of STFT is:

$${S}_{n} = {e}^{- jwn} [ x ( n ) * w ( n ) ] {e}^{jwn} ; where$$

$$w ( n ) = \{ \begin{matrix}0.54 - 0.46 cos [ \frac{2 πn}{L - 1} ] & 0 \leq n \leq L - 1 \\ 0 & else\end{matrix} ; where$$

L is a window length, and
w(n) is a Hamming window function.

In S3, STFT is performed on the noisy signals to obtain spectral amplitudes of the noisy signals, absolute values of the spectral amplitudes of the noisy signals are calculated, the spectral amplitudes of the noisy signals are corrected by using a PAS algorithm, and the corrected spectral amplitudes are used as training samples.

Considering a correlation of single frames, surrounding frames are concatenated together as a training sample, and an expression of the training sample is:

$$Training data = \{ \begin{matrix}sample \text{:} ( {S}_{noisy ( n - 3 )} , ( {S}_{noisy ( n - 2 )} , … , {S}_{noisy ( n + 3 )} ) \\ target \text{:} {S}_{clean ( n )}\end{matrix} ;$$

where

S_{clean} is a signal obtained after STFT is performed on the clean signal x(n); and

S_{noisy} is a signal obtained after STFT is performed on the noisy signal y(n).

To reduce an error of the training sample, phase aware scaling (PAS) is introduced to reduce an error caused by a phase change. Only when a phase difference between the noisy signal and the clean signal is less than 45 degrees, human ears are insensitive to distortion caused by a phase change of a signal. A formula for correcting a spectral amplitude of the noisy signal by using the PAS algorithm based on this principle is:

$${S}_{PAS} = {S}_{noisy} cos ( {θ}_{clean} - {θ}_{noisy} ) ;$$

θ_{clean} represents a phase angle of the clean signal; and
θ_{noisy} represents a phase angle of the noisy signal.

In S4, amplitudes of the training sample and the target sample are normalized, and are then input to a denoising convolutional encoding-decoding neural network for training; and normalization processing is separately performed on the training sample and a target vector. Through normalization processing, not only a convergence speed is accelerated, but an effect exerted by a singular sample value with relatively large or small overall data on model training is also eliminated. A formula for normalizing the amplitudes of the training samples is:

$${s}_{noisy \_ re} = [ {S}_{noisy} - mean ( {S}_{n o i s y} ) ] / std ( {S}_{noisy} ) ;$$

a formula for normalizing the amplitudes of the target samples is:

$${S}_{clean \_ re} = [ {S}_{clean} - mean ( {S}_{clean} ) ] / std ( {S}_{clean} ) ;$$

S_{clean} is a signal obtained after STFT is performed on the clean signal x(n); and
S_{noisy} is a signal obtained after STFT is performed on the noisy signal y(n).

In S5, a trained denoising convolutional encoding-decoding neural network is optimized by using a loss function, to obtain a pipeline leakage detection and denoising model. The denoising convolutional encoding-decoding neural network extracts features in the first convolutional layer, allows the extracted features to enter a normalization layer (BN layer) and an activation layer (ReLU layer) in sequence, and then to a first convolutional module, then output data enters n denoising blocks, where a value of n is capable of being flexibly adjusted; when an input of the block is transferred to the first convolutional module N1, a dimension is first raised to obtain more features, and when an extracted feature of the first convolutional module N1 is transferred to a second convolutional module N2, a convolution kernel becomes smaller, and a local receptive field becomes smaller, to reduce leakage of features, and a quantity of channels is increased to ensure that no feature is lost. This process is an encoding (Encode) process. When an extracted feature of the second convolutional module N2 is transferred to a third convolutional module N3, the convolution kernel becomes large again, and because the perception field becomes large, a feature extraction capability becomes strong, and to reduce a calculation amount and reduce the quantity of channels, feature decoding (Decode) is implemented; finally, an output of the third convolutional module N3 is mixed with an input of the entire module by using a residual connection, to implement feature fusion; mixed features are activated by using the activation layer (ReLU layer), and an output result continues to be transferred to a next module; and at the last convolutional layer Conv last, a quantity of convolution kernels needs to be adjusted to 1 to keep consistent with the target vector, and finally, a training effect is calculated by using a regression layer loss function.

The convolutional layer: In a convolution operation, an input feature and the convolution kernel are multiplied first in a one-dimensional convolution direction, then results are accumulated, a new feature is output, and features are extracted in a frequency domain dimension.

Normalization layer: A batch normalization (BN) layer is used, and only one batch is iterated at a time. Data of different batches also has different distribution, so that data of each batch meets standard normal distribution.

Activation layer: A rectified linear unit (ReLU) function is used as an activation function. A calculation formula is f(x)=max(0, x).

Regression layer: A prediction capability of the model is evaluated by calculating half of a root mean squared error of a predicted value and a target value. The loss function is calculated according to the following:

$$loss = \frac{1}{2} {\sum }_{i = 1}^{R} {\sum }_{f = 1}^{F} {( {\hat{x}}_{i , f} ( {y}_{i , f} , W , b ) - {x}_{i , f} )}^{2} .$$

In the formula, loss represents an error value, R is a quantity of input frames, F is a frequency of a signal, x_{i,f} is a target value at a time-frequency point (i, f), that is, an amplitude of a clean spectrum signal, y_{i,f}, W, b respectively represent an input, a weight, and an offset, and \hat{x}_{i,f} is a response to the model.

Further, the loss function is calculated according to the following formula:

$$loss = \frac{1}{2} {\sum }_{i = 1}^{R} {\sum }_{f = 1}^{F} {( {\hat{x}}_{i , f} ( {y}_{i , f} , W , b ) - {x}_{i , f} )}^{2} ;$$

where
loss represents an error value;
R represents a quantity of input frames;
F is a frequency of a signal;
x_{i,f} is a target value at a time-frequency point (i, f), that is, an amplitude of a clean spectrum signal;
y_{i,f}, W,b respectively represent an input, a weight, and an offset; and
\hat{x}_{i,f} is a response to the pipeline leakage detection and denoising model.

The present disclosure provides a deep learning-based pipeline leakage detection and denoising model, and the pipeline leakage detection and denoising model is constructed by using the foregoing construction method.

The present disclosure provides a use of a deep learning-based pipeline leakage detection and denoising model to water supply pipeline leakage detection, and specific leakage detection steps are as follows:

STFT is performed on an unknown signal on which denoising needs to be performed. In this case, in addition to obtaining a frequency amplitude of a signal, a phase value of the signal needs to be reserved, and the phase value is used as a phase value of a reconstructed signal. An extracted amplitude is input into a trained deep learning model to obtain an estimated spectral amplitude of a clean signal. The signal is reconstructed through ISTFT, and an estimated signal is converted from a frequency domain dimension to a time domain dimension, thereby implementing signal denoising.

### Specific Embodiments

In this embodiment, signals such as wind sound, rain sound, and traffic noise in an ESC-50 data set are selected as noise sources for a synthesized signal. The data set randomly extracts 6000 signals from a collected total data set as clean signals. Duration of each segment of clean signal is 1 s, and 20 noise signals are selected. Duration of each noise is 5 s. During signal synthesis, a signal of 1 s is randomly intercepted from a noise signal to be synthesized with a clean signal. In this data set, four SNRs are set: 0 dB, 2 dB, 5 dB, and 10 dB. Therefore, a total quantity of signals in the data set is 24000, there are a total of 6000 noisy signals in each SNR, a ratio of the test set is set to 9:1, and specific data division is shown in Table 1.

TABLE 1

| SNR | Quantity of clean | Quantity of noise | Training | Test |
|---|---|---|---|---|
| (dB) | signals | signals | set | set |
| 0 | 6000 | 20 | 5400 | 600 |
| 2 | 6000 | | 5400 | 600 |
| 5 | 6000 | | 5400 | 600 |
| 10 | 6000 | | 5400 | 600 |
| Total | 24000 | 20 | 21600 | 2400 |

A sampling rate of a signal is 16000 Hz, a frame length is set to 256 sampling point bits with a time length of 16 ms, a frame shift is set to 64 sampling points with a time length of 4 ms, and a Hamming window is kept consistent with the frame length. Therefore, frequency resolution (Frequency Resolution)) of each frequency bin may be calculated as 62.5 Hz.

A calculation formula is:

$$Frequency Resolution = \frac{Sampling rate}{Frequency point} = \frac{16000 Hz}{256} = 62.5 Hz$$

A calculation amount may be reduced by using symmetry of DFT, that is, a spectral amplitude of original 256 STFT may be converted into 129 points (the transform is symmetric by using a point 0 as a center, and therefore only 128 spectral amplitudes of a positive half-axis need to be calculated). Generally, to consider a correlation between frames, nearby frames are connected in series as a training sample. In this study, STFT amplitudes of a total of seven frames including three frames before and three frames after a target frame of a noisy signal are used as training samples, a dimension is (129, 7), and duration is 88 ms. A target value of a regression model is an STFT amplitude of a clean signal corresponding to the target frame, a dimension is (129, 1), and duration is 16 ms.

To further reduce an error, phase aware scaling (PAS) is introduced to reduce an error caused by a phase change. Only when a phase difference between the noisy signal and the clean signal is less than 45 degrees, human ears are insensitive to distortion caused by a phase change of a signal. An amplitude of the training sample is corrected by using the PAS algorithm based on this principle, and a formula for performing correction by using the PAS algorithm is:

$${S}_{PAS} = {S}_{noisy} cos ( {θ}_{clean} - {θ}_{noisy} ) .$$

Normalization processing is separately performed on the training sample and a target vector. Through normalization processing, not only a convergence speed is accelerated, but an effect exerted by a singular sample value with relatively large or small overall data on model training is also eliminated.

A formula for normalizing an amplitudes of the training samples is:

$${s}_{noisy \_ re} = [ {S}_{noisy} - mean ( {S}_{n o i s y} ) ] / std ( {S}_{noisy} ) .$$

A formula for normalizing the amplitudes of the target samples is:

$${S}_{clean \_ re} = [ {S}_{c l e a n} - mean ( {S}_{clean} ) ] / std ( {S}_{clean} ) .$$

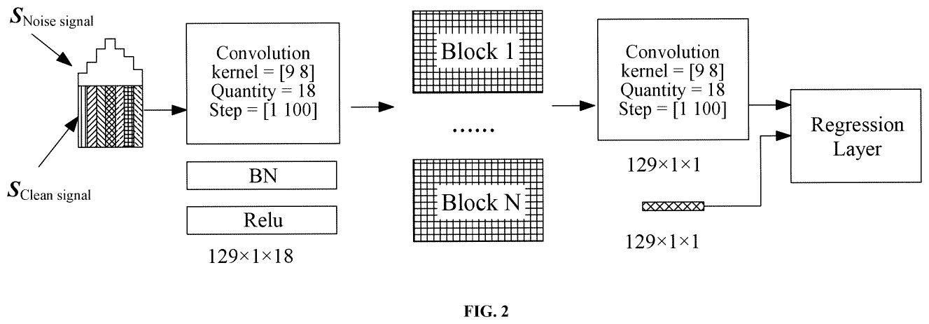

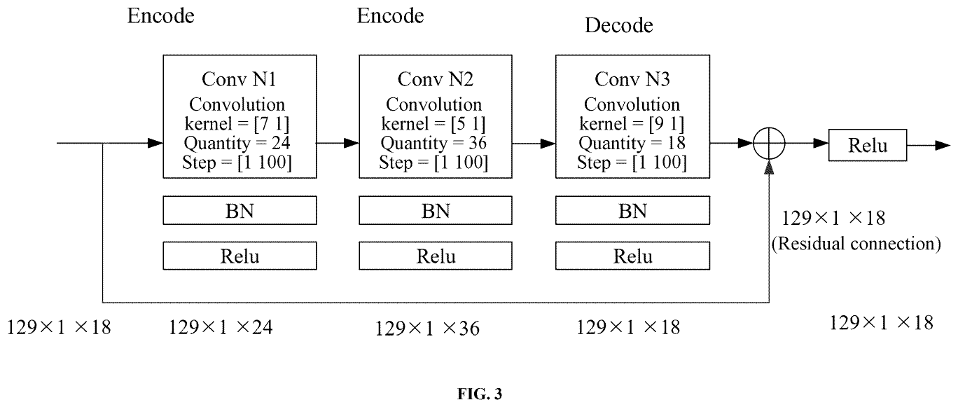

As shown in FIG. 2, features of the input training sample are extracted by using the first convolutional layer, and then the BN layer and the ReLU layer are entered in sequence. After passing through the first convolutional module, output data enters n denoising blocks, where a value of n is capable of being flexibly adjusted, and n usually increases as a scale of the data set increases to upgrade performance. A structure of the block is shown in FIG. 3. Input dimensions accepted by blocks are unified as 129×1×18, where sizes of convolution kernels are set to 9, 7, and 5, and quantities are respectively 18, 24, and 36. When an input of the block is transferred to the first convolutional module N1, a dimension is first raised to obtain more features, and when an extracted feature of the first convolutional module N1 is transferred to the second convolutional module N2, a convolution kernel becomes smaller, and a local receptive field becomes smaller, to reduce leakage of features, and a quantity of channels is increased to ensure that no feature is lost. This process is an encoding (Encode) process. When an extracted feature of the second convolutional module N2 is transferred to the third convolutional module N3, the convolution kernel becomes larger again. Because the receptive field becomes larger, a capability of extracting features becomes stronger. In this case, to reduce a calculation amount and reduce a quantity of channels, feature decoding (Decode) is implemented. Finally, an output of the third convolutional module N3 is mixed with an input of the entire module by using a residual connection, to implement feature fusion, and the mixed features are activated by using the ReLU layer, and an output result continues to be transferred to a next module. At the last convolution layer Conv last, a quantity of convolution kernels needs to be adjusted to 1 to keep consistent with the target vector, and finally, a training effect is calculated by using a regression layer loss function.

To fully compare a conventional denoising algorithm with the DECED algorithm, a segment of a leakage signal is randomly selected to form a noisy signal with a signal-to-noise ratio of 0 dB with a stationary signal and a non-stationary signal. Strength of such noise of a low signal-to-noise ratio is very high, and a denoising algorithm can be sufficiently checked.

### Denoising effect for stationary noise

Stationary noise is characterized by relatively small signal fluctuation. Common Gaussian white noise is selected as a noise signal. An amplitude of a time domain dimension of Gaussian white noise follows a Gaussian distribution, and power spectral density in frequency domain follows a uniform distribution. The Gaussian white noise has an obvious distribution rule and is a stationary signal.

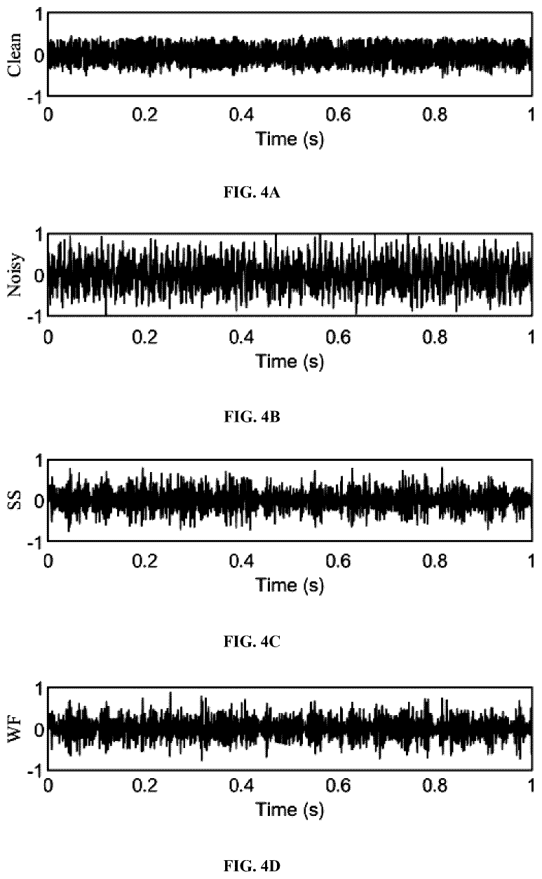

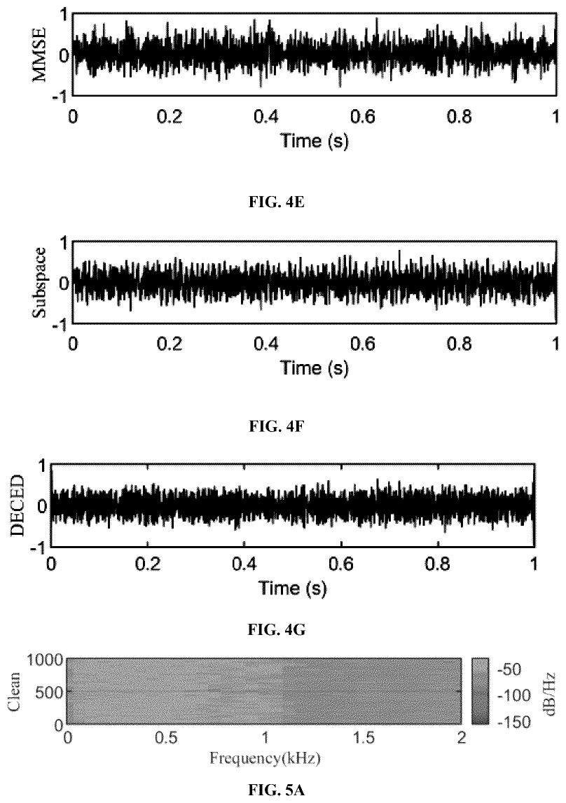

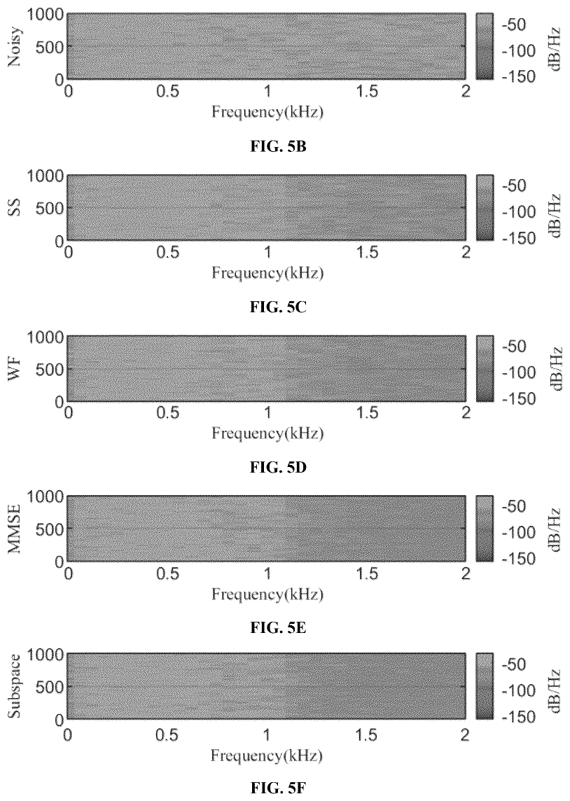

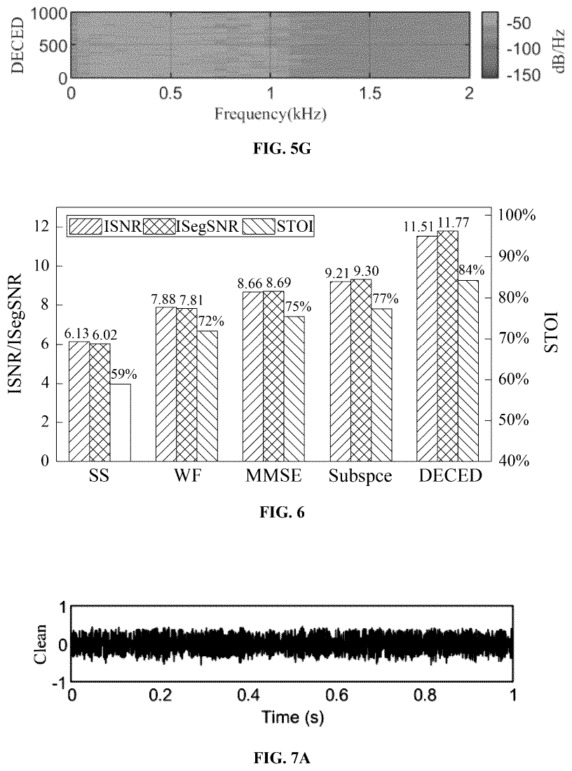

FIGS. 4A-4G and FIGS. 5A-5G show denoising effects of different methods. The denoising effect can be evaluated subjectively herein. FIGS. 4A-4G are time-history curve of a signal, where a horizontal axis is time, and a vertical axis is a normalized amplitude. FIGS. 5A-5G are STFT spectrum diagram of a signal, where a vertical axis is time (unit: ms), a horizontal axis is frequency, a cut-off frequency is limited to 0 Hz to 2000 Hz, and primary frequencies of leakage loss signals are usually distributed in this interval. Methods used are successively a spectral subtraction (SS) method, a Wiener filtering (WF) method, a minimum mean square error (MMSE) method, a subspace (Subspace) method, and a denoising convolutional encoding-decoding neural network (DECED). As shown in FIGS. 4A-4G, the uppermost part is respectively a time-history curve of a clean signal (Clean) and a time-history curve of a noisy signal (Noisy). Compared with a spectrum diagram on the right side, it may be found that signals increase obviously on a frequency band greater than 1000. Compared with five different methods, it may be found that restoration of a waveform of the clean signal is basically implemented. However, due to interference from noise, burrs are generated in each waveform of a denoising signal, and waveform distortion of different degrees occurs. A waveform of DECED is the most stable, and it is determined in time domain that denoising is implemented more thoroughly in this algorithm. From a spectrum perspective, it can be intuitively found that a signal obtained after DECED denoising is the cleanest on the frequency band greater than 1000, and a spectrum of SS is also mixed with a large quantity of noise components, and a denoising effect is the worst. Compared with denoising spectrums of WF, MMSE, and Subspace, a spectrum of Noisy is significantly improved. Based on subjective analysis in time domain and frequency domain, DECED presents a best denoising capability.

An objective indicator evaluation is performed on a signal obtained after denoising by using three indicators ISNR, ISegSNR, and STIO. As shown in FIG. 6, both ISNR and ISegSNR significantly increase. This indicates that after a noise component of a noisy signal is removed by using the denoising algorithm, a strength ratio of a clean signal is significantly improved. Values of ISNR and ISegSNR of DECED are the greatest, and are respectively 11.51 dB and 11.77 dB. A denoising effect of the SS algorithm is relatively poor. This is basically consistent with a result of subjective evaluation. It is found through analysis of a result of STOI that after denoising is performed through DECED, Subspace, MMSE, and WF, intelligibility of a signal is significantly improved, some semantic information hidden by the noise signal is released. STOI of the SS algorithm is only 59%, and intelligibility is relatively poor.

In conclusion, in all the four conventional denoising algorithms, stationary noise can be removed, and better effects are achieved especially in MMSE and Subspace. Although DECED shows the strongest performance, it does not show a great advantage for the conventional denoising algorithms. Therefore, most denoising algorithms can work well for a signal including stationary noise.

### Denoising effect of non-stationary noise

Generally, a signal characteristic of non-stationary noise changes frequently, and has strong randomness, and it is difficult to discover a rule of the non-stationary noise. Generally, traffic noise usually varies significantly, and signals are not stable, and are unstable signals. Traffic noise and a leakage signal are combined to form a noisy signal of 0 dB to detect performance of different denoising algorithms.

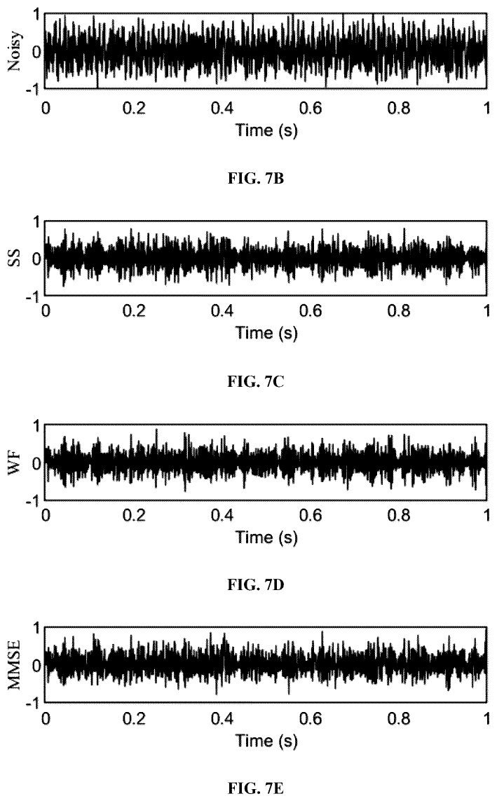

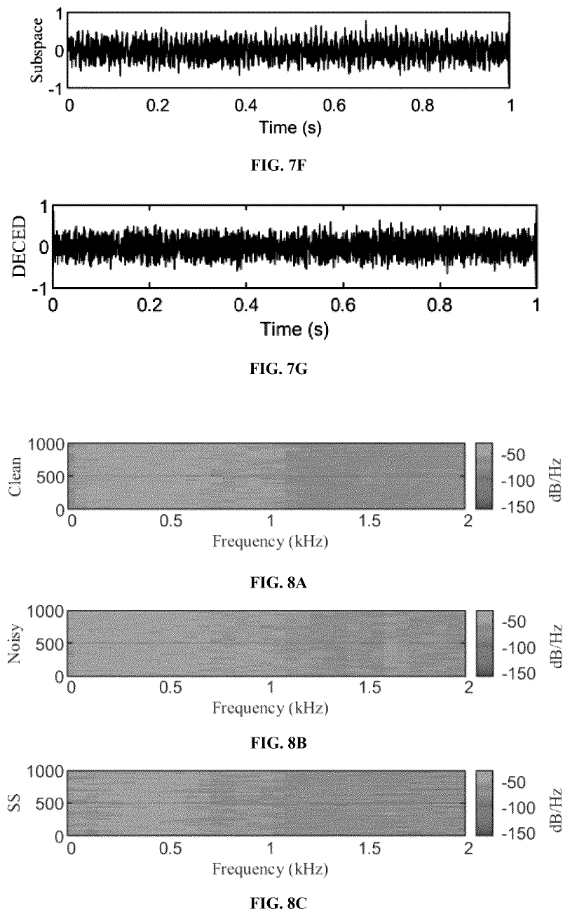

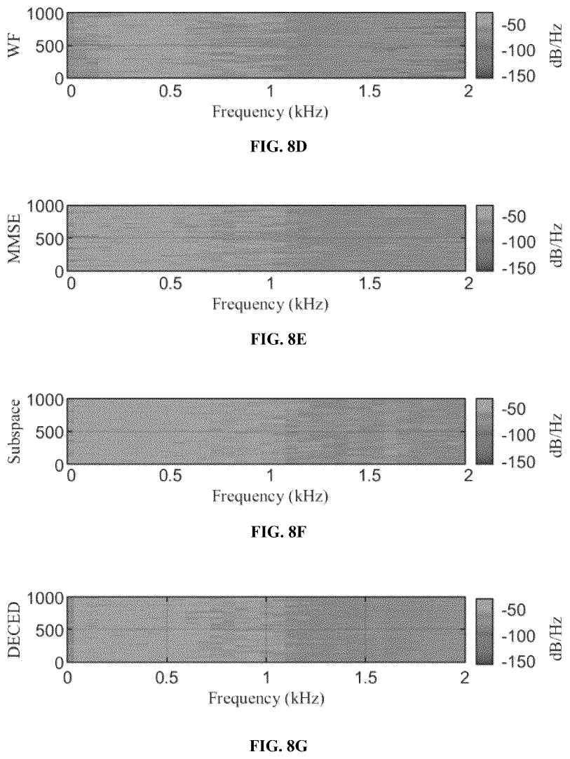

As shown in FIGS. 7A-7G, waveforms of signals processed by the SS, WF, and MMSE algorithms are distorted in a time domain dimension, and many burrs occur in a waveform of a signal processed by Subspace. Burrs are mainly generated due to noise signals. Although some burrs are also left in an algorithm obtained after DECED processing, a degree of waveform restoration of the signal by the algorithm is the highest, and is the closest to an original signal. It can be learned from spectrum analysis in FIGS. 8A-8G that noise is over-estimated in both the SS algorithm and the WF algorithm. Consequently, a large quantity of clean signals are removed, resulting in a great loss of the target signal. However, noise is underestimated in MMSE and Subspace. Consequently, a large quantity of noise signals are left in the target signal, and a purpose of denoising is not fully achieved. However, noise is well removed in DECED, which is basically consistent with a spectrum diagram of a clean signal. Therefore, DECED has the best removal effect for non-stationary noise.

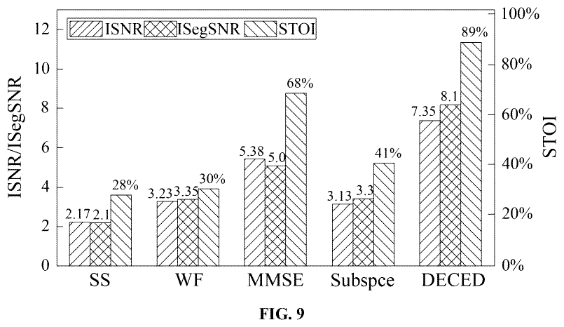

An objective evaluation indicator is used to analyze a denoising result. As shown in FIG. 9, although ISNR and ISegSNR of the SS algorithm and the WF algorithm are increased, STOI is very low, which indicates that useful information is removed during denoising. Improvement of a signal-to-noise ratio of noise is also limited in MMSE and Subspace. Through MMSE processing, an STOI of the signal reaches 68%. Although limited noise is removed, valid information of the signal is greatly excavated. The Subspace algorithm still does not get rid of the masking of the noise to the signal, and the STOI is still very low, and cannot capture the valid information. However, the signal-to-noise ratio is sufficiently improved in the DECED algorithm, and the STOI reaches 89%, which indicates that intelligibility of the signal is very high, and that the validity of the signal can be discovered. The objective evaluation indicator illustrates a capability of DECED to remove non-stationary noise.

In conclusion, the four conventional denoising algorithms lack a capability of removing non-stationary noise, and are prone to overestimation and underestimation of noise. Overestimation may lead to a loss of a target clean signal, causing distortion of the signal, and underestimation of noise may lead to incomplete removal of noise, resulting in concealment of the clean signal by noise, and consequently, valid information in the signal cannot be adequately captured, and subsequent leakage loss detection work is affected. However, the DECED algorithm effectively removes noise without causing signal distortion. Therefore, the algorithm is suitable for removing non-stationary noise.

Although some preferred embodiments of this application have been described, those skilled in the art can make changes and modifications to these embodiments once they learn the basic inventive concept. Therefore, the appended claims are intended to be interpreted as including the preferred embodiments and all changes and modifications falling within the scope of the present disclosure.

It should be noted that technical features not described in detail in the present disclosure may be implemented by using any prior art.

What is claimed is:

1. A construction method of a deep learning-based pipeline leakage detection and denoising model, comprising:
(1) performing signal modulation on clean signals and noise signals in different proportions to obtain noisy signals with different signal-to-noise ratios;
(2) performing short-time Fourier transform (STFT) on the clean signals to extract spectral amplitudes of the clean signals, and using absolute values of the spectral amplitudes of the clean signals as target samples for model training;
(3) performing STFT on the noisy signals to obtain spectral amplitudes of the noisy signals, calculating absolute values of the spectral amplitudes of the noisy signals, correcting the spectral amplitudes of the noisy signals by using a phase aware scaling (PAS) algorithm, and using the corrected spectral amplitudes as training samples;
(4) normalizing amplitudes of the training samples and the target samples, and then inputting the amplitudes into a denoising convolutional encoding-decoding neural network for training; and
(5) optimizing the trained denoising convolutional encoding-decoding neural network by using a loss function to obtain a pipeline leakage detection and denoising model.

2. The construction method of a deep learning-based pipeline leakage detection and denoising model according to claim 1, wherein the noisy signal in step (1) is obtained by scaling the noise signal and superimposing scaled noise with the clean signal;
when it is assumed that the noise signal is d(n) and the clean signal is x(n), the noisy signal y(n) is:
$$y ( n ) = x ( n ) + α d ( n ) ;$$
and
a signal-to-noise ratio SNR of the noisy signal y(n) is:
$$SNR = 10 {log}_{10} \frac{{\sum }_{i = 1}^{n} {x}^{2} ( n )}{{\sum }_{i = 1}^{n} {d}^{2} ( n )} ;$$
wherein
α is a scaling coefficient and is calculated according to the following formula:
$$α = \sqrt{\frac{{\sum }_{i = 1}^{n} {x}^{2} ( n )}{{10}^{\frac{SNR}{10}} {\sum }_{i = 1}^{n} {d}^{2} ( n )}} .$$

3. The construction method of a deep learning-based pipeline leakage detection and denoising model according to claim 1, wherein a formula of STFT is:
$${S}_{n} = {e}^{- jwn} [ x ( n ) * w ( n ) ] {e}^{jwn} , wherein$$
$$w ( n ) = \{ \begin{matrix}0.54 - 0.46 cos [ \frac{2 π n}{L - 1} ] & 0 \leq n \leq L - 1 \\ 0 & else\end{matrix} ,$$
L is a window length, and
w(n) is a Hamming window function.

4. The construction method of a deep learning-based pipeline leakage detection and denoising model according to claim 1, wherein considering a correlation of single frames, surrounding frames are concatenated together as a training sample, and an expression of the training sample is:
$$Training data = \{ \begin{matrix}sample : & ( {S}_{noisy ( n - 3 )} , {S}_{noisy ( n - 2 )} , … , {S}_{noisy ( n + 3 )} ) \\ traget : & {S}_{clean ( n )}\end{matrix} ;$$
wherein
S_{clean} is a signal obtained after STFT is performed on the clean signal x(n); and
S_{noisy} is a signal obtained after STFT is performed on the noisy signal y(n).

5. The construction method of a deep learning-based pipeline leakage detection and denoising model according to claim 1, wherein a formula for correcting the spectral amplitude of the noisy signal by using the PAS algorithm is:
$${S}_{PAS} = {S}_{noisy} cos ( {θ}_{clean} - {θ}_{noisy} ) ;$$
θ_{clean} represents a phase angle of the clean signal; and
θ_{noisy} represents a phase angle of the noisy signal.

6. The construction method of a deep learning-based pipeline leakage detection and denoising model according to claim 3, wherein a formula for normalizing the amplitudes of the training samples is:
$${S}_{noisy \_ re} = [ {S}_{noisy} - mean ( {S}_{noisy} ) ] / std ( {S}_{noisy} ) ;$$
and
a formula for normalizing amplitudes the amplitudes of the target samples is:
$${S}_{clean \_ re} = [ {S}_{clean} - mean ( {S}_{clean} ) ] / std ( {S}_{clean} ) ;$$
wherein
S_{clean} is a signal obtained after STFT is performed on the clean signal x(n); and
S_{noisy} is a signal obtained after STFT is performed on the noisy signal y(n).

7. The construction method of a deep learning-based pipeline leakage detection and denoising model according to claim 1, wherein the denoising convolutional encoding-decoding neural network extracts features in the first convolutional layer, allows the extracted features to enter a normalization layer and an activation layer in sequence, and then to a first convolutional module, then output data enters n denoising blocks, wherein a value of n is capable of being flexibly adjusted; when an input of the block is transferred to the first convolutional module N1, a dimension is first raised to obtain more features, and when an extracted feature of the first convolutional module N1 is transferred to a second convolutional module N2, a convolution kernel becomes smaller, and a local receptive field becomes smaller, to reduce leakage of features, and a quantity of channels is increased to ensure that no feature is lost; when an extracted feature of the second convolutional module N2 is transferred to a third convolutional module N3, the convolution kernel becomes large again, and because the perception field becomes large, a feature extraction capability becomes strong, and to reduce a calculation amount and reduce the quantity of channels, feature decoding is implemented; finally, an output of the third convolutional module N3 is mixed with an input of the entire module by using a residual connection, to implement feature fusion; mixed features are activated by using the activation layer, and an output result continues to be transferred to a next module; and at the last convolutional layer, a quantity of convolution kernels needs to be adjusted to 1 to keep consistent with a target vector, and finally, a training effect is calculated by using a regression layer loss function.

8. The construction method of a deep learning-based pipeline leakage detection and denoising model according to claim 1, wherein the loss function is calculated according to the following formula:
$$loss = \frac{1}{2} {\sum }_{i = 1}^{R} {\sum }_{f = 1}^{F} {( {\hat{x}}_{i , f} ( {y}_{i , f} , W , b ) - {x}_{i , f} )}^{2} ;$$
wherein
loss represents an error value;
R represents a quantity of input frames;
F is a frequency of a signal;
x_{i,f} is a target value at a time-frequency point (i, f), that is, an amplitude of a clean spectrum signal;
y_{i,f}, W, b respectively represent an input, a weight, and an offset; and
\hat{x}_{i,f} is a response to the pipeline leakage detection and denoising model.

9. A deep learning-based pipeline leakage detection and denoising model, wherein the pipeline leakage detection and denoising model is constructed by using the construction method according to claim 1.

10. The deep learning-based pipeline leakage detection and denoising model according to claim 9, wherein the noisy signal in step (1) is obtained by scaling the noise signal and superimposing scaled noise with the clean signal;
when it is assumed that the noise signal is d(n) and the clean signal is x(n), the noisy signal y(n) is:
$$y ( n ) = x ( n ) + α d ( n ) ;$$
and
a signal-to-noise ratio SNR of the noisy signal y(n) is:
$$S N R = 10 {log}_{10} \frac{{\sum }_{i = 1}^{n} {x}^{2} ( n )}{{\sum }_{i = 1}^{n} {d}^{2} ( n )} ;$$
wherein
α is a scaling coefficient and is calculated according to the following formula:
$$α = \sqrt{\frac{{\sum }_{i = 1}^{n} {x}^{2} ( n )}{{10}^{\frac{SNR}{10}} {\sum }_{i = 1}^{n} {d}^{2} ( n )}} .$$

11. The deep learning-based pipeline leakage detection and denoising model according to claim 9, wherein a formula of STFT is:
$${S}_{n} = {e}^{- jwn} [ x ( n ) * w ( n ) ] {e}^{jwn} , wherein$$
$$w ( n ) = \{ \begin{matrix}0.54 - 0.46 cos [ \frac{2 π n}{L - 1} ] & 0 \leq n \leq L - 1 \\ 0 & else\end{matrix} ,$$
L is a window length, and
w(n) is a Hamming window function.

12. The deep learning-based pipeline leakage detection and denoising model according to claim 9, wherein considering a correlation of single frames, surrounding frames are concatenated together as a training sample, and an expression of the training sample is:
$$Training data = \{ \begin{matrix}sample : & ( {S}_{noisy ( n - 3 )} , {S}_{noisy ( n - 2 )} , … , {S}_{noisy ( n + 3 )} ) \\ traget : & {S}_{clean ( n )}\end{matrix} ;$$
wherein
S_{clean} is a signal obtained after STFT is performed on the clean signal x(n); and
S_{noisy} is a signal obtained after STFT is performed on the noisy signal y(n).

13. The deep learning-based pipeline leakage detection and denoising model according to claim 9, wherein a formula for correcting the spectral amplitude of the noisy signal by using the PAS algorithm is:
$${S}_{PAS} = {S}_{noisy} cos ( {θ}_{clean} - {θ}_{noisy} ) ;$$
wherein
θ_{clean} represents a phase angle of the clean signal; and
θ_{noisy} represents a phase angle of the noisy signal.

14. The deep learning-based pipeline leakage detection and denoising model according to claim 11, wherein a formula for normalizing the amplitudes of the training samples is:
$${S}_{noisy \_ re} = [ {S}_{noisy} - mean ( {S}_{noisy} ) ] / std ( {S}_{noisy} ) ;$$
and
a formula for normalizing amplitudes the amplitudes of the target samples is:
$${S}_{clean \_ re} = [ {S}_{clean} - mean ( {S}_{clean} ) ] / std ( {S}_{clean} ) ;$$
wherein
S_{clean} is a signal obtained after STFT is performed on the clean signal x(n); and
S_{noisy} is a signal obtained after STFT is performed on the noisy signal y(n).

15. The deep learning-based pipeline leakage detection and denoising model according to claim 9, wherein the denoising convolutional encoding-decoding neural network extracts features in the first convolutional layer, allows the extracted features to enter a normalization layer and an activation layer in sequence, and then to a first convolutional module, then output data enters n denoising blocks, wherein a value of n is capable of being flexibly adjusted; when an input of the block is transferred to the first convolutional module N1, a dimension is first raised to obtain more features, and when an extracted feature of the first convolutional module N1 is transferred to a second convolutional module N2, a convolution kernel becomes smaller, and a local receptive field becomes smaller, to reduce leakage of features, and a quantity of channels is increased to ensure that no feature is lost; when an extracted feature of the second convolutional module N2 is transferred to a third convolutional module N3, the convolution kernel becomes large again, and because the perception field becomes large, a feature extraction capability becomes strong, and to reduce a calculation amount and reduce the quantity of channels, feature decoding is implemented; finally, an output of the third convolutional module N3 is mixed with an input of the entire module by using a residual connection, to implement feature fusion; mixed features are activated by using the activation layer, and an output result continues to be transferred to a next module; and at the last convolutional layer, a quantity of convolution kernels needs to be adjusted to 1 to keep consistent with a target vector, and finally, a training effect is calculated by using a regression layer loss function.

16. The deep learning-based pipeline leakage detection and denoising model according to claim 9, wherein the loss function is calculated according to the following formula:
$$loss = \frac{1}{2} {\sum }_{i = 1}^{R} {\sum }_{f = 1}^{F} {( {\hat{x}}_{i , f} ( {y}_{i , f} , W , b ) - {x}_{i , f} )}^{2} ;$$
wherein
loss represents an error value;
R represents a quantity of input frames;
F is a frequency of a signal;
X_{i,f} is a target value at a time-frequency point (i, f), that is, an amplitude of a clean spectrum signal;
Y_{i,f}, W, b respectively represent an input, a weight, and an offset; and
\hat{x}_{if} is a response to the pipeline leakage detection and denoising model.
